(19) United States
(12) Patent Application Publication
(10) Pub. No.: US 2006/0227574 A1
(43) Pub. Date: Oct. 12, 2006

(54) Linear tube night light with changeable light patterns

(76) Inventor: Tseng-Lu Chien, Shi-Chi Town (TW)

Correspondence Address: BACON & THOMAS, PLLC, 625 SLATERS LANE, FOURTH FLOOR, ALEXANDRIA, VA, 22314, US

(21) Appl. No.: 11/092,742

(22) Filed: Mar. 30, 2005

(51) Int. Cl. H01R 33/00

(52) U.S. Cl. 362/641

(57) ABSTRACT

The linear tube night light with changeable light patterns included a light source which selected from the group combination from LED, strobe light, neon light, gradation light, black light, LED inside tube, high voltage discharge light, arc light, fluorescent light, EL wires, EL twisted light, EL panels light, EL strips with changeable light patterns by automatically or manually control means to get the light patterns from one to others patterns which may selected from chasing, random, fade in and fade out, pair flashing, scan, flashing, steady on, gradation neon effects, lighted length changing, color changing, sequential flashing, any other combinations from convention market available functions. The linear tube night light with changeable patterns further incorporate with light sensor, sound sensor, timer to get the predetermined light effects, duration.

This is related to the July 2004, Fiber Optic light kits for footwear Ser. Nos. 10/883,747 and 10/954,189 and 10/667,787 and 10/286,871. and the recently filing “Multiple functions night light”, “Multiple function wall cover plate”, “Night light with fiber optics”.

### BACKGROUND

The co-inventor's prior arts U.S. Pat. No. 5,926,440, U.S. Pat. No. 6,158,868, U.S. Pat. No. 6,170,958, U.S. Pat. No. 6,171,117, U.S. Pat. No. 6,280,053, U.S. Pat. No. 6,179,431 and U.S. Pat. No. 6,270,229 disclosure arrangement for the conductive means for night light and multiple functions night light incorporated with time piece. The other U.S. Pat. Nos. 4,218,637, 4,350,929, 4,358,170, 4,386,296, 4,454,451, 4,494,041, 5,039,915, 5,301,456, 4,947,291, 5,345,149, 5,495,402, 5,662,408, 5,713,655, 5,803,579, 5,816,682, 5,833,350, 5,893,626, 5,998,928, 6,000,807, 6,010,228, 6,031,958, 6,033,087, 6,056,420, 6,132,072, 6,160,948, 6,161,910, 6,183,101, 6,190,017, 6,290,368, 6,337,946, 6,386,730, 6,390,647, 6,00,104, 6,400,104, 6,411,524, 6,431,719, 6,509,832, 6,523,976, 6,550,949, 6,609,812, 6,623,416, 6,641,289, 6,648,496, 6,709,126 show all the different light source and application but there is no one teach the night light incorporated with the linear light means with changeable light pattern. The current invention disclosure a brand new and exciting accent light which not only offer basic night light illumination but also offer a changeable light patterns to make the boring illumination to a imagination light device to offer people more dreaming and consideration hints while look at the changeable light patterns night light.

The linear tube night light with changeable patterns, the linear tube is in a linear configuration such as straight, curved, shaped, geometric design with light beam emit out along its elongated length to viewer. The linear tube means may selected from the group combination from:

(L1) neon tube,

(L2) black tube,

(L3) EL wires inside tube, EL strips inside tube (as co-pending Ser. No. 10/286,871), twisted EL elements inside tube,

(L4) LEDs inside tube,

(L5) gradation light inside tube,

(L6) high voltage discharge tube, arc light tube,

(L7) fluorescent tube,

(L8) gas filled bulbs inside tube,

The linear tube night light with changeable light patterns of current invention, the linear tube can emit the visible wavelength will be change while the circuit means offer the different electric signals to the light means. The changeable patterns may selected from the group combination from (f1) chasing, (f2) random, (f3) fade in and fade out, (f4) pair flashing, (f5) scan, (f6) flashing, (f7) steady on, (f8) gradation neon effects, (f9) lighted length changing, (f10) color changing, (f11) sequential flashing, (f12) any other combinations from convention market available functions.

The linear tube night light with changeable patterns as current invention, further incorporate with (d1) sensor device or (d2) timer device, or (d3) control device, (d4) rotating device to make the circuit means to offer the desired electric signals to turn the linear tube means for desired light show, functions, effects, under predetermined time period, duration.

The linear tube night light with changeable patterns as current invention, The said night light may further incorporated medium means which may selected from group combination from (m1) Oil, (m2) solid plastic body, (m3) light passing though material, or (m4) any medium means which can cause the light have reflective, diffusion, optics properties can incorporate with the said linear tube to increase the value, appearance, accent of the said night light.

The changeable light patterns will create the said night light's light beam with visible wavelength changed to be seen by the viewer to get the splendid light appearance and delicate light applications for building, house, residence place, dark environment, commercial areas for all the outlet receptacles around the people living areas.

### DRAWING

FIG. 1: Disclosure the variety embodiments for A, B, C, D, E with different configuration of night light and linear tube.

FIG. 2: Disclosure the variety embodiments for linear tube night light with changeable light pattern of current invention, the linear tube have different changeable patterns as (AA), (BB), (CC), (DD), (EE), (FF), (GG),(HH), (II) with details descriptions.

FIG. 3: Disclosure the variety of embodiments of linear tube night light with changeable light patterns of the current invention for linear tube with changeable patterns functions as (JJ), (KK), (LL), (MM), (NN), (OO), (PP) with details description.

FIG. 4: Disclosure the variety of embodiments of linear tube night light with changeable light patterns of the current invention, the said linear tube (Q), (R), (S), (T), (U), (V), (W) with preferred construction and electric connection depend on the requirement.

FIG. 5, Disclosure the preferred embodiment (X) with desired linear tube, housing, rotating prong means to let people see whole circle neon linear tube from front view and side view.

### DETAIL DESCRIPTION

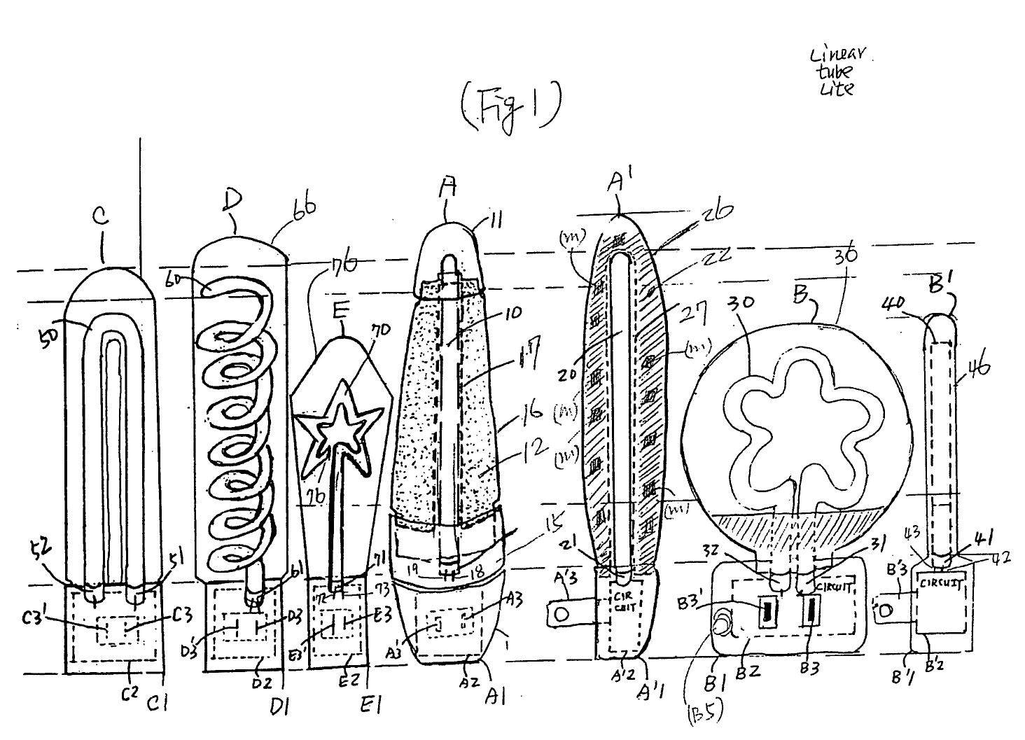

From FIG. 1, disclosure a variety of the embodiments of the said linear tube night light with changeable pattern (A) (A′) (B) (B′) (C) (D) (E). The embodiment (A) have the Base (A1) which install the circuit means (A2) and prong means (A3) (A3′) to let the prong means can be connected with the power source to get the electricity to circuit means (A2) to turn on the linear tube (10) for illumination pass though the medium means (12) to make the light beams with desired reflective and waving patterns do not need any circuit output changing. The medium means which may be selected from group of combination of (m1) water (m2) chemical (m3) oil with different density and color (m4) reflective piece (m5) solid medium material to make the linear tube light beams with optics properties such as reflective, diffusion effects. The preferred medium means (12) are sealed within a fully transparency housing (16) with a center channel (17) to allow the linear tube (10) can be install with shock and vibration protection device (not shown). The medium housing (16) are attached on the top housing (11) and lower housing (15) to make the two ends of the linear tube been covered to make nice appearance. The base (A2) fixed the lower housing (15). The electrode(s) or terminal(s) of the linear tube are connected with circuit means (A2) by conventional skill or method with circuit means (A2) for get the electric signals to turn on linear tube as expectation. The electrodes (18) (19) of the linear tube (10) are on the one end because whole medium means housing (16) is transparency so can not use the electrodes on two end type of linear tube for this application.

From embodiment (A′), disclosure the alternative construction. The medium media (22) are sealed inside housing (26) with very nice optics properties basing on a certain number of the miniature means (m) are within the said medium media (22) which may be any material such as shell, leaves, dry flower, potpourri, flower, plastic piece, floating stuff, fish, smiling face, metal piece, paper piece, wood piece, or any material with designed shape and colors which available to put inside the medium means to increase the value appearance to let the medium means (26) look like conventional gift items which including a scene inside such as seasonal water ball, artificial aquarium, kids toy with sealed liquid applications. The medium media (26) have a center channel to allow to install the linear tube which may have the diameter from 2 mm to 30 mm with preferred length from 0.5 inch to 60 inch for its length. A base (A′1) to offer a space to install the prong means (A′3) and circuit means (A2′) with proper connection means to build the electric signals delivery from power source to the linear tube light means.

From embodiment (B), disclosure the round housing (36) which install a shaped linear tube (30) with two electrodes (31) (32) on each end and connected with circuit means (B2) by conventional available skill or method to get the electric signals from the circuit means to make the light means have desired functions and effects. The prong means (B3) (B3′) and circuit means (B2) are install inside the base (B1). A manual control means (B5) arranged on the base (B1) to allow the people to make the said night light from the 1^{st} light function change to other function by manual control means to get visible light with different function of the said 1^{st} function which may select from the group combination from (f1) chasing, (f2) random, (f3) fade in and fade out, (f4) pair flashing, (f5) scan, (f6) flashing, (f7) steady on, (f8) gradation neon effects, (f9) lighted length changing, (f10) color changing, (f11) sequential flashing, (f12) any other combinations from convention market available functions while the control means offer the electric signals to control means (B5) and circuit means to drive linear tube to change function. The linear tube (30) means may selected from the group combination from:

(L1) neon tube,

(L2) black tube,

(L3) EL wires inside tube, EL strips inside tube (as co-pending Ser. No. 10/286,871), twisted EL elements inside tube,

(L4) LEDs inside tube,

(L5) gradation light inside tube,

(L6) high voltage discharge tube, arc light tube,

(L7) fluorescent tube,

(L8) gas filled bulbs inside tube,

(L9) cold cathode tube

The said night light (B) has preferred electric connection of the linear tube (30), circuit means (B2), control means (B5), prong means (B3) (B3′) to build the electric delivery from prong means (B3) (B3′) to the light means (30) to get desired light effects and functions under predetermined time, period, duration.

From embodiment (B1′) can see a linear tube (40) are sealed a geometric shape of housing (46) with the electrodes (42) (43) connected with circuit means (B′2) and prong means (B′3). The base (B′1) to attach with housing (46) and prong means (B′3) to make a linear tube night light with changeable light patterns with automatically control means inside the circuit means to make the light pattern changing as requirement. The automatically control means can easily get from the Integrated circuit (hereafter as IC) which can be get from conventional market available models.

From embodiment (D), The linear tube (60) are in a spiral, twisted, coiled, cylinder shape to make a nice and value appearance. The light function with patterns changeable for multiple colors such as 3 colors on the top, middle, lower portion of the said linear tube. The linear tube also can have the motion function such as the light will move from top to end with back and forth cycles which similar with scan functions. The linear tube may use the neon tube, high voltage discharge tube, or multiple LEDs on a flexible printing circuit board (hereafter as PCB) so can get the said scan functions to make a motion light with continuously pattern changeable while the power source been connected with prong means (D3) (D′3). The circuit means (D2) with build in IC to make the pattern changing automatically without any manual switch needed. The housing (66) sealed the linear tube (60) and attached with the base (D1) to make the linear tube night light with changeable patterns be a perfectly units.

From embodiment (D), the linear tube (70) in a star shape. The one end (76) is visible from the housing (76), the other end (71) with two electrodes (72) (73) to connect with the circuit means (E2) and the circuit means (E2) connect with prong means (E3) (E3′) to power source. The circuit means with build in IC to make the star with variety patterns changing automatically which may selected from changing length while use the neon tube with its circuit, stream of electricity while use the high voltage discharge tube. It also can use the LEDs on the flexible PCB to fit into flexible and bendable tube to get sequential, random, pair flashing, scan, fade in and fade out, steady on, all flashing, all steady on or other light functions as wished.

From embodiment (C), the linear tube (50) are in a reverse U-shape and two electrodes (51) (52) are connect with the circuit board (C2) and install on base (C1). The prong means (C3) (C′3) are connect with wall outlet receptacles or extension cord receptacles to get power to drive the linear tube with desired functions and effects.

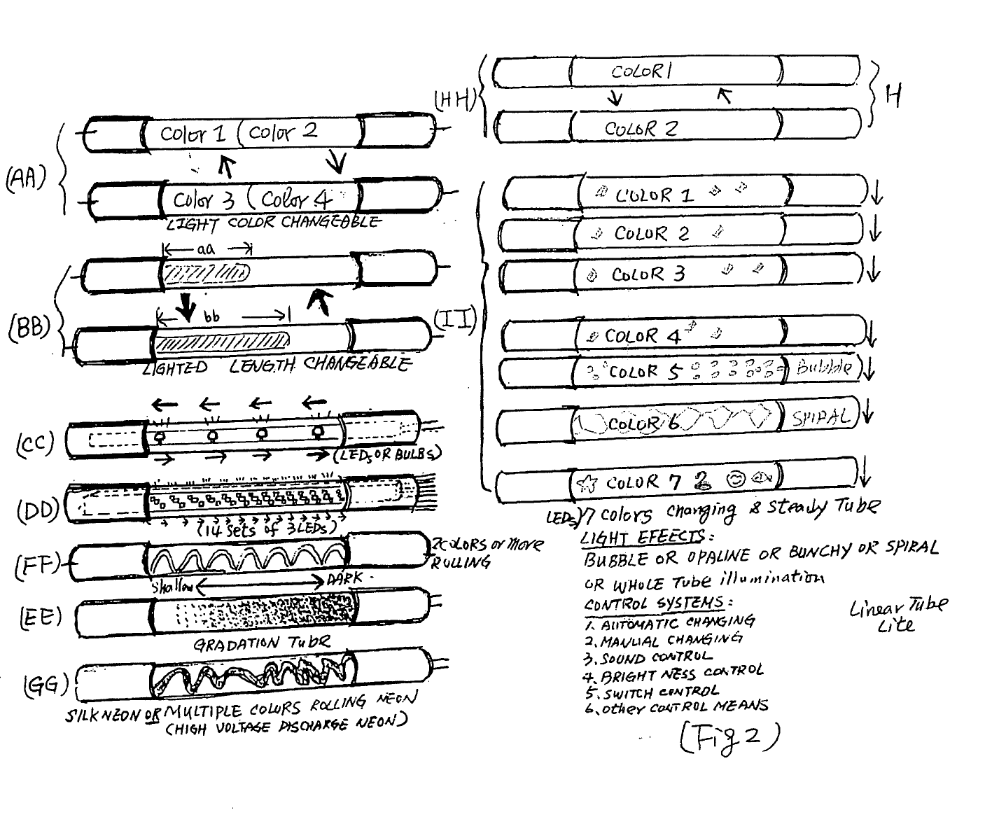

From FIG. 2, disclosure the embodiment (AA) (BB) (CC) (DD) (EE) (FF) (GG) (HH) (II) to make details description of patterns changing of linear tube.

From embodiment (AA), the tube can have the multiple color such as color 1 and color 2 and can be change pattern to the color 3 and color 4. The said tube can be a neon tube or LEDs inside a tube. While use the neon tube, the color change can be get simple to make the circuit means with different outputs to cause the neon tube to change colors from the original colors. While use the LEDs inside the tube, The most simple is to use the Red and Green and Blue (hereafter as RGB) to have proper steady on and timing control to make the RGB to mixed the color to get the color change. It also can have special made LED to make this color change.

From embodiment (BB), the tube can have the lighted length changed from short (aa) to longer length (bb) or any length with automatically changing the light pattern or controlled by the sound sensor etc. The tube may selected the neon light or LEDs inside the tube. Changing the electric signals output from the circuit means can easily to get the lighted length changed to make patterns changing as expectation.

From embodiment (CC), the tube with multiple LED or gas filled bulb or neon bulb or other spot light source inside the rigid or flexible tube means. The proper circuit means with IC to make the variety spot light means to have fade in and fade out, sequential, flashing, random, chasing, pair flashing, scan, steady on or any combination of these functions with desired on-time, duration, period, cycles to create the incredible and eye-catching effects.

From embodiment (DD), the tube has a plurality of areas with RGB LEDs arrangements. The RGB LEDs with proper on-time, sequential, time, period and cycles control by IC can created the desired colors and functions and effects. The LEDs can use chip, dice, and sealed unit in variety shape to make the desired dimension to fit into rigid or flexible tube means for proper application of said the night light.

The sealed unit of RGB unit can be have one single shaped LED with color changeable instead of the 3 piece of shaped LED units to get the same function. This will be a benefits to fit the single shape LED into a tiny space of the application such as make a single shaped LED with RGB dice inside for C-7 bulb shape to fit into C-7 base for light source.

From embodiment (EE) disclosure the gradation tube means with flexible and bendable tube means. The gradation light can make from LEDs, EL, OEL, OLED and conventional neon lamp with gradation phosphor arrangement or from the front surface filter treatment to get these effects for gradation effects as convention market available gradation light tube.

From embodiment (FF) disclosure the silk lighted areas or the multiple colors lighted areas with rolling light effects. The tube can have the features while you place your hand on the said multiple color linear tube, a stream of electricity will change the light patterns with exciting light effects. The electricity streams are motional at all the time while the prong means are connected with power source and circuit means to offer the electric signal to the said linear tube of (GG).

From embodiment (HH) disclosure the color change from color 1 to color 2 and on the other time the color will change back from color 2 to color 1. This kind of color change can use conventional LEDs, EL, OEL, OLED, neon, high voltage discharge tube, EL wires, EL twisted panels, EL coiled strips as light means to get such effects with automatically or manual control means to make this function.

From embodiment (II) disclosure the color change from color 1→2→3→4→5→6→7 which color changing can get from the light source selected from LEDs, EL, OEL, OLED with proper circuit and light means arrangement. The LEDs can arranged on the end of the tube means to make cost lower. The tube means can be as medium means with rigid or soft material with solid material within. The preferred application to use the solid material with treatment along the elongate length with bubble, opaque or bunchy or spiral arrangement within the tube to make the light beams have the other dedicated design for illumination. It also can use earlier discussion of the medium means with miniature materials (such as fish, smile face, star, swan, metal piece, paper piece, plastic piece) inside the medium means to get expected optics properties.

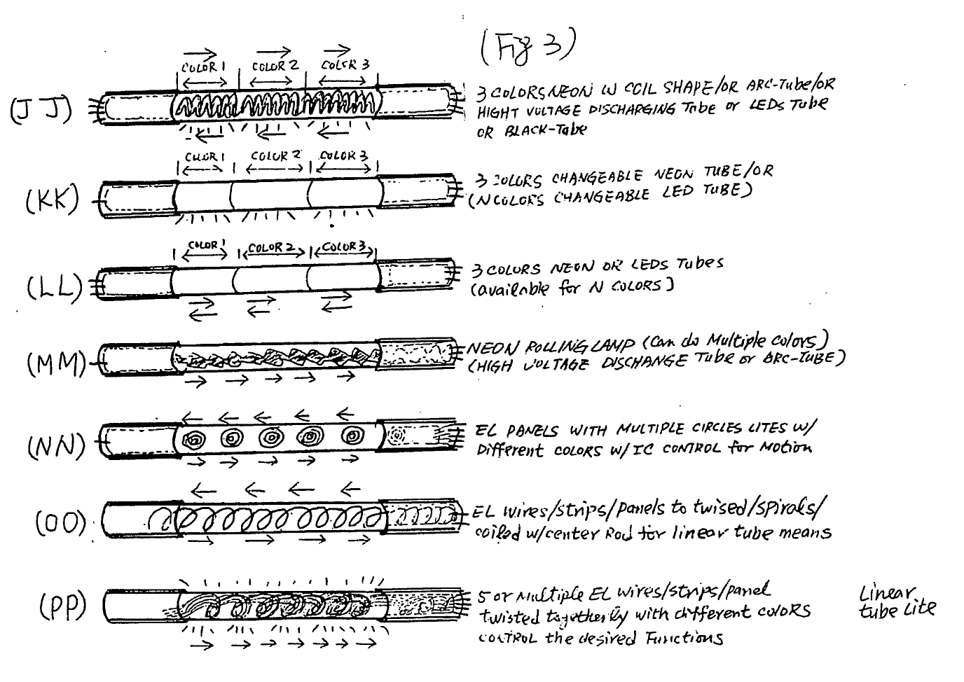

From FIG. 3 disclosure a plurality of the linear tube arrangement.

From embodiment (JJ) (KK) (LL) disclosure the 3 colors coil shape of linear tube. The light means can be selected from neon, high voltage discharge tube, gradation tube, LEDs inside the tube, gas filled bulb inside tube to get this arrangement. The proper circuit means will drive these 3 colors tube for desired functions which can have any combination from earlier discussed function (f1) to (F12) for 12×12 assortment light function with automatically or manual control means to make light function as wish

From embodiment (MM) for the rolling motion light which can be a neon or high voltage discharge tube which have the electricity stream moving within the tube all the time while the power source is connected to the circuit means to drive the linear tube with this function. It also can have other actively motion effects for this application while the hand to touch on the said light means, the stronger electricity streams will become stronger. This is a very good pattern changing application.

From embodiment (NN) for EL, OEL, OLED application with the phosphor areas with different color on selected shape and size so can make the desired shaped lighted areas with desired color. Under the proper circuit means can drive the said shaped lighted areas to be turned on as desired functions which as earlier discussion of (f1) to (f12). Same as embodiment (OO) which use the EL, OEL, OLED strips, wires, panel to be twisted, coiled, spirals with center rod or metal piece to make a tube design which same as the co-pending filing Ser. Nos. 10/286,871 and 10/107,584 and 10/341,519 and prior issued patent U.S. ______ (three dimensional EL elements).

The embodiment (PP) disclosure the multiple EL wires twisted together to make the linear tube with desired light function. The each EL wires similar a individual light means under IC control will get a splendid light effects and functions. The functions can be selected from the earlier discussion from (f1) to (f12) or any combination for these 12×12 assorted of light functions.

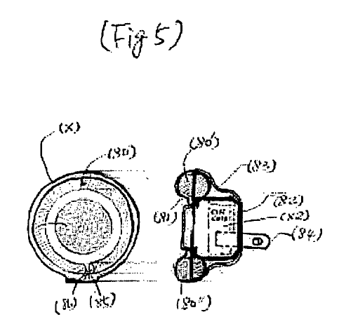

From FIG. 5, Disclosure a round neon tube night light with changeable light patterns. The night light (X) has a linear tube (80) with two electrodes (85)(86) to connected with the circuit means (X2) by conventional skills. From the side view, the linear tube (80′) (80″) as a circle install on the front housing (81) and back housing (82) and outer case (83). The back housing with prong means (84) and circuit means (x2) installed and sealed with front housing (81) to allow the prong means can be rotating to any orientation. The conventional linear tube means has diameter such as neon can do from 2 mm to 15 mm, but also can do any diameter depend on market requirement. For strobe tube common diameter around 4 mm but also can do customer design.

For LED light within the tube can do any size because LED has dice, chip, or sealed unit for very tiny dimension. For black tube, gradation tube, discharge tube, cold cathode tube, and EL, OEL, OLED also can do any customer design without any difficulty.

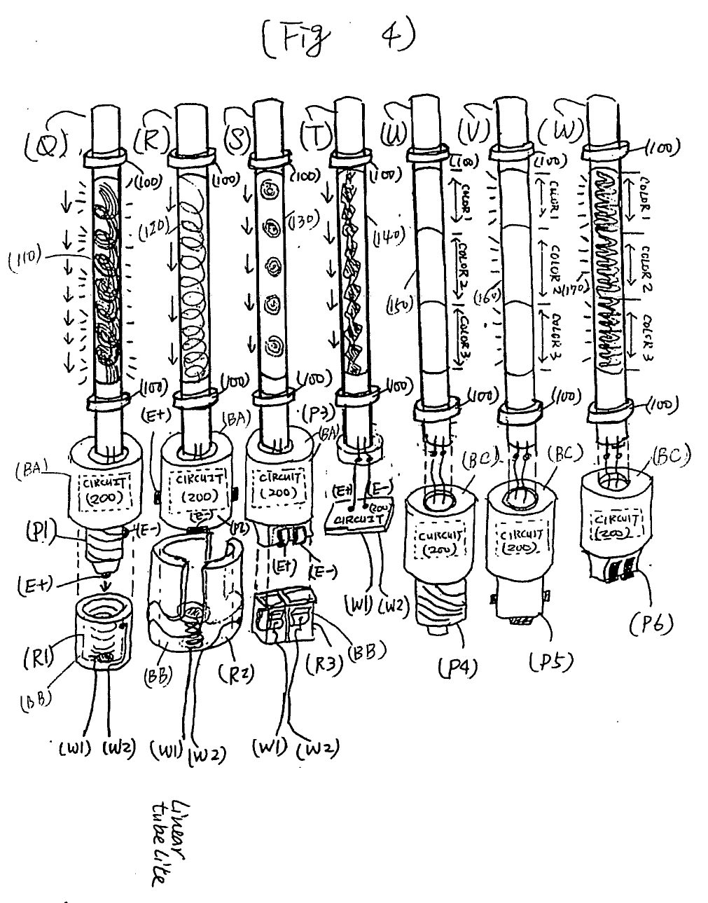

From FIG. 4 disclosure the variety arrangement for linear tube connect and installation. From embodiment (Q) disclosure the light means (110) are install on a base (BA) and the base with prong base ( )1) with contact means (E+) (E−) to insert into the receive base (R1) of the receptacle base (BB). The circuit means (200) are inside the base (BA) with electric connection with the linear tube (110). The base (BA) is a screw type base as other bulb base. The embodiment (R) is similar with the conventional market bulb base as bayot base. The embodiment (S) is similar with the conventional market bulb base as wedge base. The embodiment (T) do not use any base or prong base or receptacle base but only a circuit means (200) connect with linear tube (140) and output wires (W1) (W2) to connect with desired power source. The linear tube's electrodes (140) and circuit (200) and wires (W1) (W2) are well inside a housing (not show) to make the safety application of the said night light. From the embodiment (U) (V) (W) to disclosure the linear tube (150) (160) (170) use the wires and soldering method to connect with base (BC) with a space distance to make the desired arrangement. From the FIG. 4 preferred embodiments can tell the installation for the linear tube with the circuit means and base means have variety arrangement and designs depend on the market requirement and space consideration. This above discussed embodiments should not limit the spirits of the current invention for the linear tube night light with changeable light patterns. It is appreciated that should be including all the alternative method, equivalent functions replacement, similar treatment, equivalent arrangement, further incorporating with additional functions 1 should be consider still fall within the scope of the current invention. Hereof, our claims as following:

1. The linear tube night light with multiple functions including:
At least one of prong means build in the said night light and supply the electricity to the said circuit mean while the said prong means are connected with the power source.
At least one of the linear tube means is a linear configuration such as straight, twisted, coiled, curved, shaped, spiral, circle, or other geometric designs with light beam emit out along its elongated length to viewer.
The linear tube means may selected from the group combination from:
(L1) neon tube,
(L2) black tube,
(L3) EL wire(s) inside tube, EL strip(s) inside tube (as co-pending Ser. No. 10/286,871), twisted EL elements inside tube,
(L4) LEDs inside tube,
(L5) gradation light inside tube,
(L6) high voltage discharge tube, arc light tube,
(L7) fluorescent tube,
(L8) gas filled bulbs inside tube,
(L9) cold cathode tube
The said night light has preferred electric connection of the linear tube, circuit means, control means, prong means, switch means to build the electric delivery from prong means to the light means to get desired light effects and functions under predetermined time, period, duration.
At least one of protective means protect the linear light means from impact damage.
The protective means and linear light means dispose within the preferred transparency housing.
The said circuit means, control means, prong means, switch means, connect means, linear tube's terminal(s) dispose within preferred non-transparent or translucent housing.
The improvement including:
The said night light has the 1^{st} light performance while the prong means connected with power source. The light performance may selected from the group combination from (p1) functions, (p2) colors, (p3) light patterns, (p4) image size, (p5) lighted area dimension, (p6) other light image physical properties.
The said functions which may select from the group combination from (f1) chasing, (f2) random, (f3) fade in and fade out, (f4) pair flashing, (f5) scan, (f6) flashing, (f7) steady on, (f8) gradation neon effects, (f9) lighted length changing, (f10) color changing, (f11) sequential flashing, (f12) any other combinations from convention market available functions.
The said 1^{st} light performance will change to other performance by automatically control means or manual switch means to get next performance as listed from (p1) to (p6) and (f1) to (f12).
The linear tube night light with changeable light patterns not only offer an illumination but offer a multiple effects to viewer.

2. The linear tube night light with changeable light patterns as claim 1, the said control means incorporated with switch device, sensor device, Integrated circuit (IC) device, motion means, sound means, scent means, sound activated means to make the said night light can make function selection from multiple functions IC chip by switch device.

3. The linear tube night light with changeable light patterns as claim 1, the said housing of linear tube further incorporated with medium means which may be selected from group of combination of (m1) water (m2) chemical (m3) oil and chemical(s) with different density and color (m4) reflective piece (m5) solid medium material to make the linear tube light beams with optics properties such as reflective, diffusion effects or cause the image changing.

4. The linear tube night light with changeable light patterns as claim 1, the said linear tube can be a rigid or a flexible material depend on the said light means physical properties.

5. The linear tube night light with changeable light patterns as claim 1, the said linear tube have the visible length between the 0.2 to 60 inch measured from the end to end.

6. The linear tube night light with changeable light patterns as claim 2, the said switch means can select one of the functions from the said (f1) to (f12) and fix this function for the said night light.

7. The linear tube night light with changeable light patterns as claim 3, the said medium means are sealed inside part of the said transparency housing.

8. The linear tube night light with changeable light patterns as claim 1, the said tube has diameter between the 2 mm to 30 mm with rigid or flexible material depend on the different kind of light means.

9. A linear tube night light with changeable light patterns, including:
At least one of prong means to connect with power source.
At least one of the linear light means with light beam emit along elongate length to viewer. The said linear light means connect with circuit means to get electric signals for desired light functions and performance.
At least one of housing to install the said prong means, circuit means, linear light means on desired position with preferred configuration and dimension.
At least one of switch means install on the surface of the said housing.
The said linear light means emit out the light beams while the said prong means connected with power source.
The improvement:
The said night light has the 1^{st} light performance while prong means connect with power source and change to the next performance while the switch means been operated.
The said light performance can be selected from any combination of color, frequency, voltage, brightness, length, intensity, lighted-area, and function(s).
